(19) United States
(12) Patent Application Publication
(10) Pub. No.: US 2020/0177586 A1
(43) Pub. Date: Jun. 4, 2020

(54) BIOMETRIC SYSTEMS, APPARATUS AND METHODS

(71) Applicant: Arm IP Limited, Cambridge (GB)

(72) Inventor: Jason Souloglou, Cheshire (GB)

(21) Appl. No.: 16/701,139

(22) Filed: Dec. 2, 2019

(30) Foreign Application Priority Data
Dec. 3, 2018 (GB) 18 19712.9

(51) Int. Cl. H04L 29/06

(52) U.S. Cl. CPC H04L 63/0861; H04L 63/20

(57) ABSTRACT

The present techniques generally relate to a method of determining, at an apparatus, an authentication status for a user, the method comprising: processing user biometric data; deriving a biometric identifier from the biometric data; verifying the user's identity based on or in response to the biometric identifier; deriving a state identifier from the biometric data; determining a state of the user based on or in response to the state identifier; determining the authentication status for the user based on or in response to the user's identity being verified and the state of the user.

This application claims the benefit of priority to UK patent application number GB1819712.9 filed on 3 Dec. 2018, which is incorporated herein by reference in its entirety.

### BACKGROUND

The present techniques generally relate to biometric systems, methods, and apparatuses, and particularly, but not exclusively, to such systems, methods, and apparatuses for authenticating an associated user.

Biometric systems capable of identifying a user from a biometric input are known, whereby a user can be identified via a fingerprint or using facial recognition. Such devices may be used to provide access to a resource on verifying the user using the biometric input.

The present techniques seek to provide improvements over the prior art.

### BRIEF DESCRIPTION OF THE DRAWINGS

The present techniques are diagrammatically illustrated, by way of example, in the accompanying drawings, in which:

FIG. 1 illustratively shows a block diagram of an apparatus according to an embodiment;

FIG. 2a illustratively shows a system comprising an apparatus according to an embodiment;

FIG. 2b illustratively shows a system comprising an example apparatus of FIG. 1 according to a further embodiment;

FIG. 3 illustratively shows an example electrocardiogram (ECG) signal according to an embodiment;

FIGS. 4a and 4b illustratively show simplified communication diagrams for an example system of FIG. 2a according to an embodiment;

FIGS. 5a and 5b illustratively show simplified communication diagrams for an example system of FIG. 2b according to an embodiment; and

FIG. 6 illustratively shows a simplified flow diagram of a method for determining an authentication status for a user and determining an action to take based, at least in part, on and/or responsive to an authentication status according to an embodiment.

### DETAILED DESCRIPTION

According to a first technique there is provided a method of determining, at an apparatus, an authentication status for a user, the method comprising: processing user biometric data; deriving a biometric identifier from the biometric data; verifying the user's identity based on or in response to the biometric identifier; deriving a state identifier from the same biometric data; determining a state of the user based on or in response to the state identifier; determining the authentication status for the user based on or in response to the user's identity being verified and the state of the user.

According to a further technique there is provided an apparatus for determining an authentication status for a user operable to: process user biometric data; derive a biometric identifier from the same biometric data; verify the user's identity based on or in response to the biometric identifier; derive a state identifier from the biometric data; determine a state of the user based on or in response to the state identifier; determine the authentication status for the user based on or in response to the user's identity being verified and the state of the user.

According to a further technique there is provided an apparatus for determining an authentication status for a user operable to: process user biometric data; derive a biometric identifier from the biometric data; verify the user's identity based on or in response to the biometric identifier; derive a state identifier from the biometric same data; determine a state of the user based on or in response to the state identifier; determine the authentication status for the user based on or in response to the user's identity being verified and the state of the user.

The present techniques provide systems, methods, and apparatuses for authenticating a user and will be described more fully hereinafter with reference to the accompanying drawings. Like numbers refer to like elements throughout.

According to the present techniques, an apparatus comprising a biometric device generates biometric data for an associated user, whereby the biometric data may be generated from one or more sources including: cardiac (electrocardiogram (ECG)) signals generated based on or in response to the user's heartbeat; brain (electroencephalogram (EEG)) signals generated based on or in response to the user's brain activity; iris recognition signals generated based on or in response to scanning the user's iris; facial recognition signals generated based on or in response to analysing one or more of the user's facial features; voice recognition signals generated based on or in response to the user's vocalisations; chemical analysis signals generated based on or in response to analysing one or more of the user's bodily fluid(s), tissue(s) or scent(s) or thermal signals (e.g. thermal infrared (IR) signals) generated based on or in response to an analysis of the user's heat signature (e.g. using a thermal camera). It will be appreciated that the sources of biometric data provided above are exemplary only, and the biometric data may be generated from other sources. As referred to herein, the terms “biometric data” and “biometric signals” shall be interchangeable.

Using the present techniques, the apparatus comprising a biometric device and/or a further apparatus, for example comprising a server, may derive a biometric identifier from the biometric data which may be used to verify the identity of the user and may also derive a biometric state identifier from the biometric data to determine a physiological state (hereafter “state”) of the user. As will be appreciated by a person skilled in the art on reading the present specification, physiological state includes one or more of: a physical, an emotional, and a psychological state of the user although these are examples of such a physiological state and the claims are not limited in this respect.

The apparatus can then determine an authentication status for the user based on or in response to user's identity being verified and the determined state of the user.

The apparatus can then take an action based on the authentication status, whereby the action may be taken in accordance with one or more policies or rules relating to the authentication status. For example, a policy may define one or more permissions for a user having a particular authentication status or may define what action should be taken by an apparatus when a user is determined to have a particular authentication status.

The term “user” as used herein is to be interpreted broadly, and, in embodiments, refers to a subject (e.g. a human, animal) having an associated apparatus comprising a biometric device. Such a biometric device may be attached to the user (e.g. worn or applied to the skin or clothing) or the biometric device may be within the user's body (e.g. implanted or ingested). In other examples, the biometric device may be remote from the user, and may generate the biometric data by scanning or sensing the user.

The term “resource” as used herein is to be interpreted broadly, and in embodiments the resource may be a physical resource that opens/closes (e.g. a door) or is turned on/off (e.g. a switch, a vehicle ignition, a drug administration system). In some embodiments the resource may be an on-line resource such as a database (e.g. a folder with restricted files or data (e.g. passwords)), a user account (e.g. a bank account or betting account) or the like. In other embodiments the resource may be a person or animal, whereby such a resource maybe instructed to perform an action. It will be appreciated that these resources are exemplary only the list of example resources is not exhaustive.

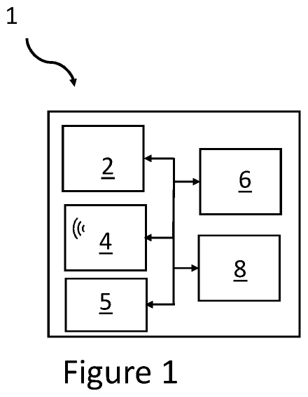

FIG. 1 illustratively shows a block diagram of an apparatus 1 according to an embodiment, whereby the apparatus depicted in FIG. 1 comprises a biometric device 1 having sensor circuitry 2 for generating biometric data.

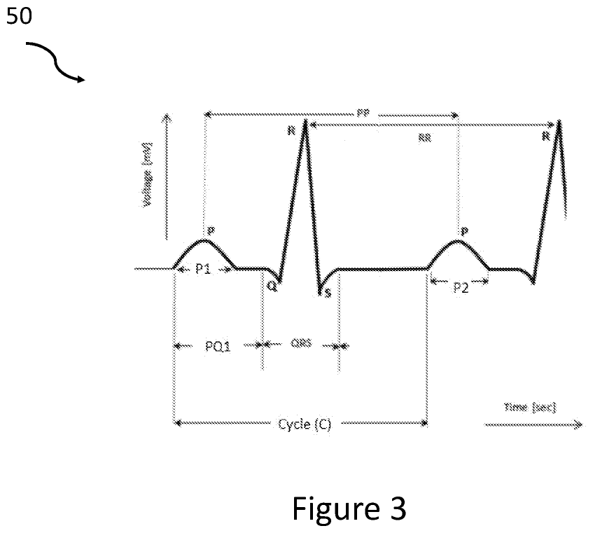

In embodiments the sensor circuitry 2 comprises electrocardiograph (ECG) circuitry 2 to generate ECG signals for an associated user based on or in response to the user's heartbeat. As an illustrative example, the ECG circuitry 2 comprises one or more pairs of electrodes applied to a user's skin, whereby the one or more pairs of electrodes measure the change of electric potential therebetween, whereby the resulting ECG signal relates to the cardiac activity of the associated user, and the characteristics of the ECG signal can be used to verify the identity of the user and to determine a state of the user as described in more detail in FIG. 3 below.

The sensor circuitry 2 is not limited to being ECG circuitry and may comprise any suitable sensor circuitry as will be appreciated by a person skilled in the art taking account of the teachings herein.

As an illustrative example, the sensor circuitry 2 may comprise chemical analysis circuitry to analyse bodily fluid (e.g. blood, saliva, urine), tissue (e.g. skin), or odours. In examples the chemical analysis circuitry may be provided as a lab-on-a-chip (LoC), which may be implanted in, or ingested, by the user, or with which the user may interact with to provide a sample to be analysed. In other examples, the chemical analysis circuitry may be provided as a breath analyser, into or onto which a user exhales. As further illustrative examples, the sensor circuitry may comprise EEG circuitry, iris recognition circuitry, facial recognition circuitry, voice recognition circuitry, breath analysis circuitry etc.

It will also be appreciated that the biometric data generated by the biometric device 1 may be generated by different types of sensor circuitry. For example, the biometric identifier may be derived from biometric data generated by ECG circuitry, whilst the biometric state identifier may be derived from biometric data generated by chemical analysis circuitry.

The biometric device 1 comprises communication circuitry 4 for transmitting the biometric data to a remote apparatus (not shown in FIG. 1).

The remote apparatus may comprise, for example, a mobile device (e.g. mobile phone, tablet, laptop), a computer terminal, or computing infrastructure for controlling access to a resource(s) over one or more networks (e.g. cellular networks, local area network (LAN), wireless LAN, a wide area networks (WAN)) such as the internet or other types of networks).

The communication circuitry 4 may comprise wired communications (e.g. a universal serial bus (USB), lightening connector or the like) and/or may comprise wireless communications (e.g. radio frequency identification (RFID), Bluetooth®, Bluetooth Low Energy (BLE®), WIFI®, cellular (e.g. 3G®/4G®/5G® etc) or the like).

The biometric device 1 also comprises power circuitry 5. In embodiments the power circuitry 5 may comprise a power source such as a battery. The power source may comprise an energy harvester as a standalone power source or in addition to the battery (e.g. to charge the battery), whereby the energy harvester may harvest energy from mechanical vibrations or from electromagnetic signals (e.g. Wi-Fi signals).

The biometric device 1 may also comprise processing circuitry 6 to control the operations of the various circuitry, and may further comprise storage circuitry 8, such as volatile/non-volatile storage.

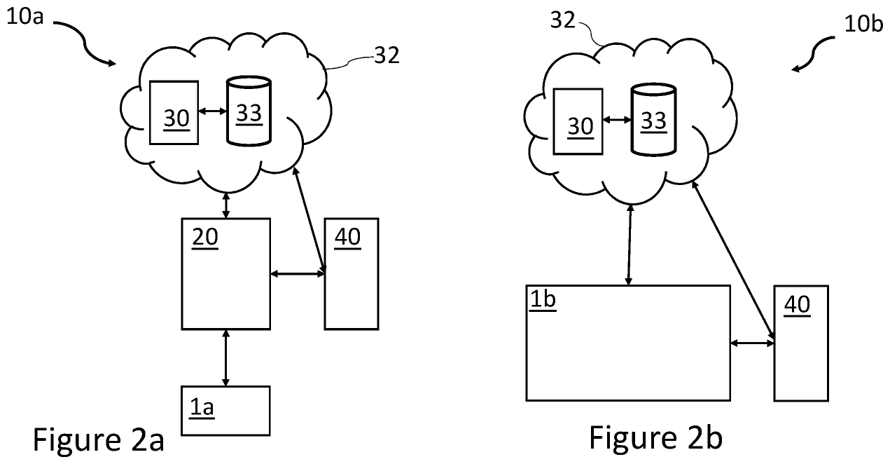

In some embodiments, as illustratively depicted by system 10a of FIG. 2a, the biometric device 1a may have only limited capabilities (e.g. power/storage/processing capabilities) and may transmit the generated biometric data to a further apparatus 20 for processing 21 thereat. Such biometric devices 1a having limited processing may be those implanted or ingested by a user or incorporated into clothing (e.g. a vest, jumper, shorts) a fashion accessory (e.g. a watch, glasses, bracelet) worn by a user.

The apparatus 20 may then process the biometric data and/or may provide the biometric data to a further apparatus 30 for processing thereat, whereby on processing the biometric data and authenticating the user, the apparatus 20/30 may provide the user with access to a resource 40 (e.g. in accordance with a policy).

Apparatus 30 may be embodied as computing infrastructure comprising one or more hardware and/or software components such as servers (e.g. lightweight machine-to-machine (LwM2M) servers), storage, load balancers, gateways and the like, whereby such an apparatus 30 may provide one or more services, which may include one or more of: a web service; data storage service, analytics service, management service and application service although this list is not exhaustive. Such a service may comprise a public cloud service on a public cloud infrastructure; a private cloud service on a private cloud infrastructure; on-premise service hosted on a private infrastructure; and a hybrid cloud service comprising a combination of the public, private and/or on-premise services.

In other embodiments, as illustratively depicted by system 10b in FIG. 2b, the apparatus may comprise a biometric device 1b having increased capabilities and functionality (e.g. processing/storage/power capabilities) than that of biometric device 1a depicted in FIG. 2a and may comprise, for example a mobile phone, tablet, laptop although this list is exemplary only, whereby the biometric device 1b may comprise the necessary processing power and applications/programs/policies to process the biometric data thereon and to determine an authentication status for the user, and take an appropriate action.

The biometric device 1b may additionally, or alternatively, transmit the biometric data to a further apparatus 30 to determine an authentication status for the user. For example, the biometric device 1b may transmit the biometric data to the apparatus 30 when the biometric device 1b is not capable of determining whether the user should be granted access to the resource 40, or when, for example, the user requests access to a resource which the biometric device 1b is not authorised to provide access to or when the biometric device 1b cannot determine an authentication status for the user.

In other examples the biometric device 1b may transmit the biometric data to the apparatus 30 for processing when the biometric device 1b does not have the necessary capabilities to process the biometric data itself (e.g. when the battery is below a certain power level; or when data in storage capacity reaches a certain size; or in view of a processor executing other applications resulting in reduced processing capabilities).

FIG. 3 shows an illustrative example of an ECG signal 50 comprising a cardiac cycle (C) for an associated user.

One or more aspects of the ECG signal are extracted (e.g. features P, Q, R, S and/or intervals between such features (e.g. P1, P2, PQ1, QRS, PP, RR) and/or the characteristics of the features such as shape, frequency, amplitude of the various features. It will be appreciated that the number of aspects extracted may be dependent on a particular application, and the claims are not limited in this respect. Furthermore, although only one cardiac cycle is depicted in FIG. 3, the aspects extracted from the ECG signal may be extracted over one or more cardiac cycles.

The one or more extracted aspects may be compared with template data in a database.

When a match between the one or more extracted aspects and the template data is identified, the identity of the user may be verified. As such, one or more aspects derived from the ECG signal 20 are used as biometric identifiers to verify the identity of the associated user.

Using the present techniques, the one or more aspects derived from the state identifier may also analysed to determine the state of the user. In some embodiments the same aspects used to verify the user are also used to determine the state of the user, but the claims are not limited in this respect.

In some embodiments, the state of the user and, therefore, the authentication status of the user may be determined independent of template data registered for that user, whereby the policy or rule defines the user state based on or in response to the one or more aspects derived from the state identifier. As an illustrative example of an ECG signal, when the frequency of the cardiac cycle falls outside a specified threshold (e.g. when the heartbeat exceeds 100 beats per minute (BPM) for a human), an action may be taken in accordance with a policy for that authentication status.

In some embodiments, the state of the user, and, therefore, the authentication status of the user, may be determined dependent on template data registered for that user, whereby the policy or rule defines the user state based on or in response to the one or more aspects derived from the state identifier when compared to the template data. As an illustrative example, when the biometric data indicates that the user is suffering a heart attack (e.g. due to an abnormality in the ECG signal in comparison to the template data registered for the user), an action may be taken in accordance with a policy for when the user is determined to be having a heart attack.

It will be appreciated that biometric data is not limited to ECG signals, and may also comprise chemical analysis signals, thermal infrared signals, iris recognition signals, facial recognition signals, breath analyser signals etc, whereby template data for the different types of signals may be registered for respective users during an enrolment process, against which the derived biometric identifiers and state identifiers can be compared for the different types of signal.

As set out above, the state of the user and, therefore, the authentication status of the user may be determined independent of template data registered for that user. As an illustrative example for a breath analyser signal, a policy may define a breath alcohol content (BrAC) threshold of 250 micrograms of alcohol per litre of breath and may further define the action to be taken when a user's BrAC is determined to exceed that threshold.

As also set out above, the state of the user, and, therefore, the authentication status of the user, may be determined dependent on template data registered for that user. As an illustrative example for a chemical analysis signal, a policy may define the action to be taken when a user's cortisol level exceeds the cortisol level in the template data by a particular margin e.g. 20%, whereby the increase in cortisol level may be indicative of stress.

The policies or rules which define the action to be taken in response to an authentication status may be stored at the biometric device 1 or further apparatus 20. In other examples, the policies or rules may be stored in storage circuitry 33 remote therefrom (depicted as database 33 hosted on the cloud in FIGS. 2a & 2b).

In embodiments, the authentication status for the user is based on or in response to the user's identity being verified and the determined state of the user.

In embodiments, the action to be taken for a particular authentication status may be defined in one or more policies or rules.

As an illustrative example, when a user's identity is not verified, the user may be determined to have a first authentication status; when the user's identity is verified the user may be determined to have a second authentication status. Furthermore, the user having a first user state may mean the user is determined to have a third authentication status; whilst the user having a second user state may mean the user is determined to have a fourth authentication status. An apparatus can then take one or more actions dependent on the determined authentication status.

An action may comprise the apparatus performing an operation thereat or generating a command to instruct another apparatus to perform an operation. Such an operation may be to provide or restrict access to a resource for a user. In other examples, such an operation may be to generate an output for a user, whereby the output may comprise a sensory output (e.g. a text message on a screen or a sound emitted from a speaker, or an apparatus vibrating).

As an illustrative example of restricting access to a resource in response to a user's authentication status, the user may be a driver attempting to open a driver's door of a motor vehicle using a key fob having a biometric device comprising a fingerprint scanning circuitry and breath analyser circuitry incorporated therein. When the user's identity cannot be verified from the biometric data transmitted to an apparatus associated with the vehicle the vehicle door will remain locked in accordance with a policy for the first authentication status for the user.

When the user's identity is verified, the apparatus may unlock the door and allow the user to start the ignition and drive the vehicle in accordance with a policy for the second authentication status for the user.

However, when it is determined that the user is drunk (e.g. from the breath analyser), the apparatus may allow the user to unlock the door but prevent the user from starting the vehicle in accordance with a policy for the third authentication status for the user.

Furthermore, biometric data may be constantly generated, or the biometric data may be generated intermittently (e.g. periodically) by the biometric device, whereby the biometric data is monitored by an apparatus, such that when the state of the user, and therefore the authentication status of the user changes, an appropriate action can be taken in accordance with a fourth authentication status.

As an illustrative example, when is determined that the alcohol levels in the user's breath sample fall below a threshold level (e.g. in accordance with a policy), the apparatus will allow the user to start the vehicle, and an alert sent to the user's phone that he is below the threshold. As a further illustrative example, when it is determined that the user is having a heart attack (e.g. from ECG signals on an associated biometric device), the apparatus may control the vehicle to perform a controlled stop and may alert an appropriate party (e.g. the police, ambulance etc.)

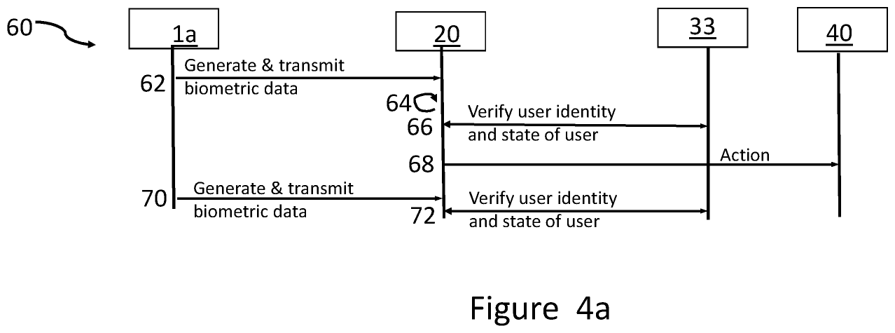

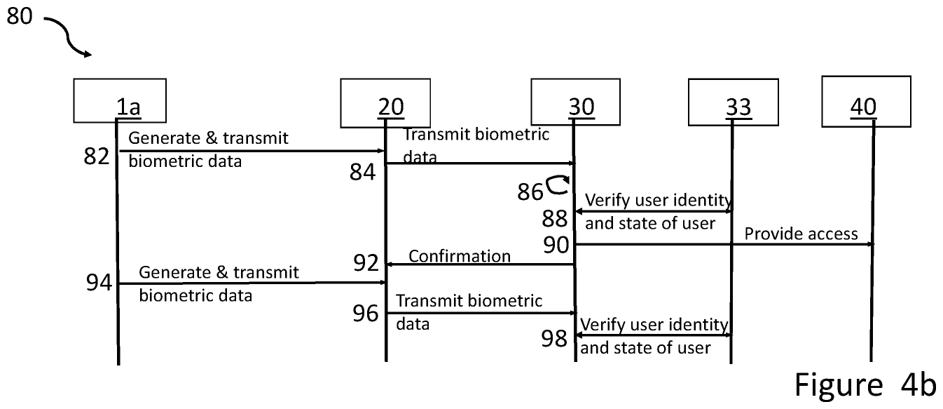

FIG. 4a is a simplified communication diagram 60 illustrating example communications in the system 10a of FIG. 2a for authenticating a user requesting access to a resource 40.

At 62 an apparatus comprising biometric device 1a associated with the user generates biometric data using associated sensor circuitry.

The biometric device 1a may have limited processing and storage capabilities, and in embodiments the biometric device 1a may be paired with device 20 and transmits the biometric data to the apparatus 20. In examples, the biometric data is generated in response to a command by the user (e.g. when the user presses a button on apparatus 20, recognised as a request to access resource 40), whilst in other examples the biometric data may be automatically generated by the biometric device (e.g. continuously or intermittently).

At 64 the apparatus 20 processes the biometric data and derives a biometric identifier from the biometric data, and further derives a biometric state identifier from the biometric data.

At 66, the apparatus 20 communicates with database 33 to determine an authentication status for the user by comparing the derived biometric identifier and biometric state identifier against template data in the database 33 to verify the user's identity and determine the user state.

The apparatus 20 can then determine what action to take based on or in response to the user's authentication status.

At 68, as an illustrative example of an action, the apparatus 20 provides the user with access to the resource 40, whereby in the present illustrative example, the resource 40 may be a vehicle door, whereby the apparatus 20 transmits a command to the vehicle door to unlock the vehicle door for a period of time. As a further example, the apparatus 20 may generate a token (e.g. cryptographic token) to be presented to a reader at the resource 40, or cause a code (e.g. alphanumeric code or barcode) to be displayed on a display screen at the apparatus 20, whereby the user can enter the code on a keypad, or present the code to a reader at the resource 40.

As depicted at 70-72, the apparatus 20 may process further biometric data to determine an updated authentication status of the user after a period of time (e.g. seconds, minutes, hours, days etc.) and take one or more actions based on the further authentication status.

It will be appreciated that the apparatus 20 may not need to verify the user's identity having verified it previously, and the updated authentication status may be determined based on the state identifier derived from the further biometric data.

Whilst the apparatus 20 is depicted as processing the biometric data in FIG. 4a, the apparatus 20 may also transmit the biometric data to a further apparatus 30 as depicted in FIG. 4b, which shows a simplified communication diagram 80 illustrating example communications in the system 10a of FIG. 2a.

The apparatus 20 may transmit the biometric data to the further apparatus 30 when the apparatus 20 cannot determine whether the user should be granted access to the resource 40, or when, for example, the user requests access to a resource which the apparatus 20 is not authorised to provide access to. In other examples the apparatus 20 may transmit the biometric data to the further apparatus 30 for processing when the apparatus 20 does not have the necessary capabilities to process the biometric data itself (e.g. when the battery is below a certain power level; or when data in storage capacity reaches a certain size; or in view of a processor executing other applications resulting in reduced processing capabilities).

At 82 the biometric device 1a associated with the user generates biometric data using associated sensor circuitry and transmits the biometric data to apparatus 20.

The apparatus 20 receives the biometric data and at 84 transmits the biometric data to further apparatus 30.

At 86 the further apparatus 30 processes the biometric data and derives a biometric identifier from the biometric data, and further derives a biometric state identifier.

At 88, the further apparatus 30 communicates with database 33 to compare the derived biometric identifier and biometric state identifier against template data in the database 33 to determine an authentication status of the user, and to determine what action to take based on or in response thereto (e.g. in accordance with one or more policies).

At 90, the further apparatus 30 provides the user with access to the resource 40.

As depicted at 94-98, the further apparatus 30 may process further biometric data from the user to determine an updated authentication status and take one or more actions based on or in response to the updated authentication status (e.g. in accordance with one or more policies).

It will be appreciated that the further apparatus 30 may not need to verify the user's identity having verified it previously, and the updated authentication status may be determined based on the state identifier derived from the further biometric data.

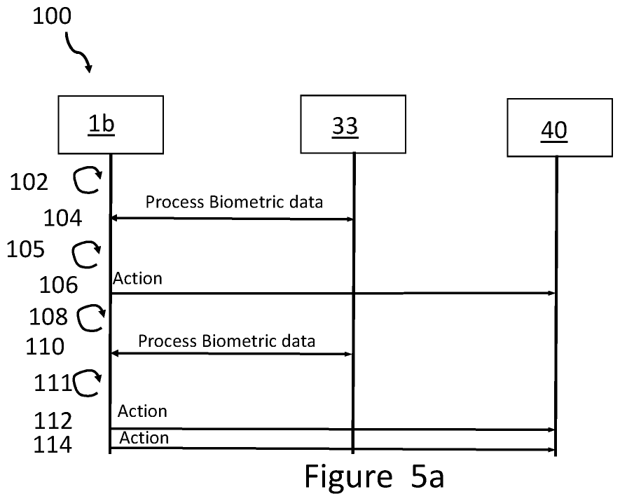

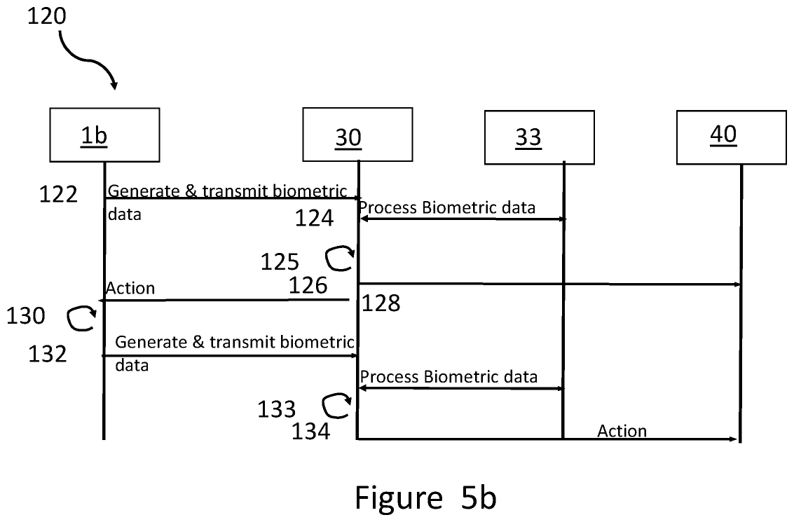

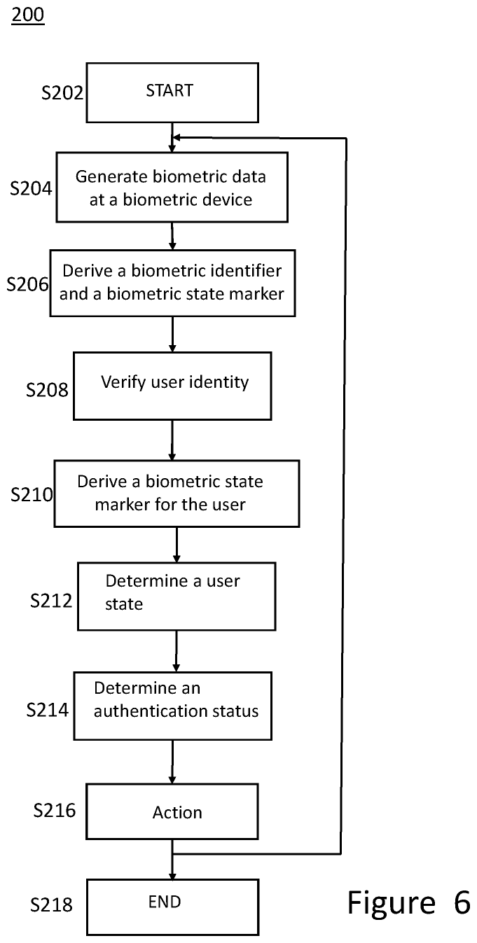

FIG. 5a is a simplified communication diagram 100 illustrating example communications in the system 10b of FIG. 2b for determining an authentication status for a user requesting access to a resource 40. For the purposes of this illustrative example, the biometric device 1b has more compute power in comparison to the biometric device 1a, although the claims are not limited in this respect.

At 102, biometric device 1b generates biometric data using associated sensor circuitry.

At 104, the biometric device 1b processes the biometric data to derive a biometric identifier and a biometric state identifier.

In the present illustrative example, determining an authentication status comprises verifying the user identity and determining the user state by communicating with database 33 to compare the derived biometric data against template data in the database. In another embodiment, the biometric device may communicate with local storage circuitry thereon (depicted by storage circuitry ‘8’ in FIG. 2b) to compare the derived biometric data against template data in the storage.

At 105, the biometric device 1b determines what action to take based on or in response to the authentication status in accordance with a policy.

In the present illustrative example, at 106 the action comprises the biometric device 1b providing the user with access to the resource 40, whereby in the present illustrative example, the resource 40 may be a drug administration system in a hospital, whereby the biometric device 1b may transmit a command to the drug administration system to deliver the drug to the user (e.g. via an intravenous (IV) line connected to the patient.

As depicted at 108-110, the biometric device 1b may generate and process further biometric data from the user, and at 111 the biometric device may determine an updated authentication status based on the further biometric data, and at 112-114 perform an action based on the updated authentication status. It will be appreciated that the biometric device 1b may not need to verify the user's identity having verified it previously, and the updated authentication status may be determined based on the state identifier derived from the further biometric data.

Following on from illustrative example above, when it is determined (e.g. from chemical analysis signals) that the drug levels in the user's body are above a threshold (e.g. as specified in a policy), or when it is determined (e.g. from abnormal ECG signals) that the user is having an adverse or unexpected reaction to the drugs, the biometric device 1b may prevent the administration of further drugs, or may command the drug administration system to administer different drugs to the patient (e.g. as depicted at 112). In a further illustrative example, the biometric device may alert an appropriate party such as a doctor (e.g. via apparatus 30 as depicted at 114). Such an action may be in accordance with one or more policies stored at the database 33 (or stored in storage circuitry on the biometric device 1b).

Therefore, in some embodiments processing the biometric data and taking an action based on the user's authentication status may be carried out at the biometric device 1b which generates the biometric data.

Additionally, or alternatively, the biometric device 1b may transmit the biometric data to a further apparatus 30 for processing thereat as depicted in FIG. 5b, which shows a simplified communication diagram 120 illustrating example communications in the system 10b of FIG. 2b for authenticating a user requesting access to resource 40.

As above, the biometric device 1b may transmit the biometric data to the apparatus 30 for processing when the biometric device 1b cannot determine whether the user should be granted access to the resource, or when, for example, the user requests access to a resource which the biometric device 1b is not authorised or capable of providing access to. In other examples the biometric device 1b may transmit the biometric data to the apparatus 30 for processing when the biometric device 1b does not have the necessary capabilities to process the biometric data.

At 122, the biometric device 1b associated with the user generates biometric data using associated sensor circuitry and transmits the biometric data to apparatus 30.

At 124 the apparatus 30 processes the biometric data and derives a biometric identifier from the biometric data, and further derives a biometric state identifier.

The apparatus 30 may then determine the user authentication status by verifying the user identity and determining the user state.

At 125, the apparatus 30 determines what action(s) to take based on or in response to the user's authentication status in accordance with a policy, and at 126-128, performs the action(s).

As depicted at 130-134, the apparatus 30 may receive and process further biometric data from the user to determine an updated authentication status and take one or more actions based on the updated authentication status in accordance with one or more policies.

It will be appreciated that the apparatus 30 may not need to verify the user's identity having verified it previously, and the updated authentication status may be determined based on the state identifier derived from the further biometric data.

FIG. 6 illustratively shows a simplified flow diagram illustrating a method 200 for determining an authentication status for a user and determining an action to take based on or in response to the authentication status.

At S202 the method starts.

At S204 biometric data is generated for a user at an associated apparatus comprising a biometric device. Such a biometric device may be attached to the user (e.g. worn or applied to the skin or clothing), or the biometric device may be within the user's body (e.g. implanted or ingested). In other examples, the biometric device may be remote from the user, and may generate the biometric data by scanning or sensing the user.

The biometric device or a further apparatus to which the biometric data is transmitted determines an authentication status for the user by verifying the user's identity and determining the state of the user.

At S206, a biometric identifier to verify an identity of a user may be derived, and at S208 a user's identity may be verified by, for example, comparing a biometric identifier to a template of aspects stored at a database (or storage circuitry).

At S210 a biometric device or further apparatus may derive a biometric state identifier from biometric signals to determine a state of a user. At S212 the state of the user is determined based on or in response to the biometric state identifier, whereby the state of the user may be determined by comparing the derived biometric state identifier with template data. Additionally, or alternatively, the state of the user may be determined independent of the template data.

At S214, the biometric device or further apparatus determines the authentication status based on or in response to the user's identity being verified and the state of the user.

At S216, the biometric device or further apparatus determines what action to take based on or in response to the user's authentication status.

The authentication status of the user may be updated based on or in response to further biometric data generated at the biometric device, whereby the method of S204 to S216 are repeated. It will be appreciated that in some embodiments the apparatus may not need to verify the user's identity having verified it previously, and the updated authentication status may be determined based on the state identifier derived from the further biometric data.

At S218 the method ends.

In embodiments, the biometric data may be transmitted in a communication which may include other information or data.

For example, the communication comprising the biometric data may be signed by the biometric device (e.g. using a symmetric or private cryptographic key) so that the identity of the signing party can be verified (e.g. using a corresponding symmetric or public cryptographic key). Such a signature provides an extra level of user verification in that the private key provisioned on the biometric device may be associated with the user whose biometric data is received in the communication, such that when the user is identified by the biometric identifier, the user's identity can be further verified by verifying the signature on the communication.

Additionally, or alternatively, the communication comprising the biometric data may be encrypted (e.g. using symmetric or asymmetric cryptography). Such functionality means that the biometric data may only be accessed by an authorised party having a corresponding key.

It will be appreciated that the keys for signing/verifying and encrypting/decrypting communications may be provisioned on the respective apparatuses, for example, during a registration process with the user.

In some embodiments the communication comprising the biometric data may include location data, which may comprise, for example, GPS (Global Positioning System) coordinates for the user. Such location data may be generated by GPS circuitry on the biometric device itself, or by a further apparatus. Using such functionality, an apparatus receiving the communication can track the user and take an appropriate action in line with one or more policies.

As an illustrative example and looking at the system of FIG. 2a, biometric data from biometric devices 1a associated with one or more doctors in a hospital may be sent to apparatus 30. Furthermore, biometric data from biometric devices 1a associated with one or more patients in the hospital may also be sent to apparatus 30. Each of the communications comprising the biometric data may also include location data to allow the apparatus 30 to track the location of the doctors and/or patients in the hospital.

When the authentication status of the patient indicates that the patient requires access to a resource (e.g. a doctor), the apparatus 30 will determine the patient's location from the location data and alert the most appropriate doctor to attend the patient.

The apparatus 30 may also determine the most appropriate doctor to attend to that patient based on or in response to the current location of all the doctors (i.e. the closest doctor to the patient). Additionally, or alternatively, the apparatus 30 may determine the most appropriate doctor(s) to attend the patient based on or in response to the authentication statuses for the respective doctors. For example, the apparatus 30 may determine that the closest doctor to the patient is fatigued or is sleeping and will alert the next closest doctor that is not fatigued. As above, the determination as to which doctor(s) is most appropriate may be based on or in response to one or more policies stored in the database 33.

Additionally, or alternatively, the communication comprising the biometric data may include time data (e.g. a timestamp such as a UNIX timestamp providing time/date). Such time data may be applied by the biometric device, for example, when the biometric data is generated or when the communication comprising the biometric data is transmitted. In some embodiments, an apparatus receiving the communication comprising the biometric data may also apply time data relating to the time the communication is received.

The apparatus receiving the communications may take an appropriate action dependent on the time data in line with one or more rules or policies.

Keeping with the illustrative example of a patient in a hospital above, when the authentication status of the patient indicates that the patient requires access to a resource (e.g. a pain relief drug because that a patient is in pain), the apparatus 30 may determine from time data associated with a previous authentication status when the patient was last provided with the pain relief drug, and from the time data associated with the latest authentication status that the necessary time between doses of the drug has not passed.

Consequently, the apparatus may indicate to the user that the drug cannot be provided until a certain time has elapsed or may provide the user with access to a different pain relief drug or may alert a doctor(s) to attend the patient (e.g. based on or in response to the authentication statuses for the respective doctors).

Whilst the techniques above generally describe the biometric identifier as a biometric signal, the biometric identifier may be a token (e.g. a cryptographic token) generated by the biometric device, or an apparatus with which it is paired. Such a token may be cryptographically signed and/or encrypted with a trusted key, such that an apparatus receiving the biometric data comprising the token may verify the user's identity by verifying the signature and/or decrypting the token. Such functionality of using a token as the biometric identifier reduces the processing burden in comparison to comparing biometric data with template data in a database.

It will be appreciated that the functionality described above means that a biometric device can function as an envoy device for an associated user, whereby the biometric device can request access to one or more resources by transmitting biometric data to an apparatus which can then provide the access based on or in response to the authentication status.

As previously described the biometric device may continuously transmit the biometric data for passive authentication in that the user does not have to actively request to access a resource and the authentication status of the user may be determined as the user approaches or comes into proximity of the resource. In a further example, the biometric device can receive a token (e.g. cryptographic token) from an apparatus, whereby the token provides access to one or more different doors of a building in accordance with a first authentication status for the user, whilst an updated token may be transmitted to the biometric device in accordance with a second authentication status.

In other examples the user may actively request access to a resource (e.g. by pressing a button on the biometric device when in proximity to a biometric data reader device associated with the resource, such that the biometric data is generated and transmitted to the biometric data reader device which can determine a user authentication status or transmit the received biometric data to a server to make the determination determine a user authentication status and provide/deny basis in response thereto.

Therefore, the present techniques provide for both passive and active authentication of the user.

Embodiments of the present techniques provide a non-transitory data carrier carrying code which, when implemented on a processor, causes the processor to carry out the methods described herein.

The techniques further provide processor control code to implement the above-described methods, for example on a general-purpose computer system or on a digital signal processor (DSP). The techniques also provide a carrier carrying processor control code to, when running, implement any of the above methods, in particular on a non-transitory data carrier or on a non-transitory computer-readable medium such as a disk, microprocessor, CD- or DVD-ROM, programmed memory such as read-only memory (firmware), or on a data carrier such as an optical or electrical signal carrier. The code may be provided on a (non-transitory) carrier such as a disk, a microprocessor, CD- or DVD-ROM, programmed memory such as non-volatile memory (e.g. Flash) or read-only memory (firmware). Code (and/or data) to implement embodiments of the techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

Computer program code for carrying out operations for the above-described techniques may be written in any combination of one or more programming languages, including object-oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

It will be understood that, although the terms first, second, etc. may be used herein to describe various features, these features should not be limited by these terms. These terms are only used to distinguish one feature from another. Furthermore, the term “and/or” includes any and all combinations of one or more of the associated listed items.

Furthermore, the terminology used herein is for the purpose of describing embodiments only and is not intended to be limiting. For example, as used herein the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In the preceding description, various embodiments of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

1. A method of determining, at an apparatus, an authentication status for a user, the method comprising:
processing user biometric data;
deriving a biometric identifier from the biometric data;
verifying the user's identity based on or in response to the biometric identifier;
deriving a state identifier from the same biometric data;
determining a state of the user based on or in response to the state identifier;
determining the authentication status for the user based on or in response to the user's identity being verified and the state of the user.

2. The method of claim 1, further comprising:
performing a first action based on or in response to the authentication status.

3. The method of claim 2, further comprising:
performing the first action in accordance with one or more rules or policies for the determined authentication status.

4. The method of claim 2, wherein the first action comprises one or more of: performing an operation at the apparatus and generating a command to instruct another apparatus to perform an operation.

5. The method of claim 4, wherein the operation comprises one or more of: providing access to a resource; restricting access to a resource; and generating an output for a user.

6. The method of claim 1, wherein verifying the user's identity comprises:
comparing one or more aspects of the biometric identifier with template data registered for the user to identify a match therebetween.

7. The method of claim 1, further comprising:
determining the state of the user dependent on template data registered for the user.

8. The method of claim 1, further comprising:
tracking the user based on or in response to location data associated with the biometric data.

9. The method of claim 1, wherein the biometric data comprises one or more of: cardiac signals; brain signals; iris recognition signals; facial recognition signals; voice recognition signals; chemical analysis signals; thermal signals; and breath analysis signals.

10. The method of claim 1, further comprising:
generating, at a biometric device, the biometric data;
transmitting, from the biometric device to the apparatus, the biometric data.

11. The method of claim 1, comprising:
processing further user biometric data;
deriving a further state identifier from the biometric data;
determining a further state of the user based on or in response to the state identifier;
determining an updated authentication status for the user based on or in response to the further state of the user.

12. The method of claim 11, further comprising:
deriving a further biometric identifier from the further biometric data;
further verifying the user's identity based on or in response to the further biometric identifier;
determining the updated authentication status for the user based on or in response to further verifying the user's identity.

13. The method of claim 11, further comprising:
performing a second action based on or in response to the updated authentication status.

14. The method of claim 13, further comprising:
performing one or both of the first action and second action based on or in response to time data.

15. An apparatus for determining an authentication status for a user, comprising:
one or more processors operable to:
process user biometric data;
derive a biometric identifier from the biometric data;
verify the user's identity based on or in response to the biometric identifier;
derive a state identifier from the same biometric data;
determine a state of the user based on or in response to the state identifier;
determine the authentication status for the user based on or in response to the user's identity being verified and the state of the user.

16. The apparatus of claim 15, wherein the apparatus comprises sensor circuitry to generate the user biometric data.

17. The apparatus of claim 15, wherein the apparatus performs an action based on or in response to the authentication status for the user.

18. A non-transitory computer readable storage medium comprising code which is executable by one or more processors to:
process user biometric signals;
derive a biometric identifier at least in part from the biometric signals;
verify an identity of the user based, at least in part, on and/or responsive to the biometric identifier;
derive a state identifier at least in part from the same biometric signals;
determine a state of the user based, at least in part, on and/or responsive to the state identifier; and
determine the authentication status for the user based, at least in part, on and/or responsive to verification of the identity of the user and the state of the user.
